(19) United States
(12) Patent Application Publication
(10) Pub. No.: US 2017/0172169 A1
(43) Pub. Date: Jun. 22, 2017

(54) SOY-BASED CHEESE

(71) Applicant: IMPOSSIBLE FOOD INC., Redwood City, CA (US)

(72) Inventors: Stephanie S. GRZANICH, Foster City, CA (US); Sue KLAPHOLZ, Stanford, CA (US); Lynn S. VOCCOLA, Pacifica, CA (US); Marjorie Ronan GRIFFITHS, San Francisco, CA (US)

(21) Appl. No.: 15/127,712

(22) PCT Filed: Feb. 23, 2015
(86) PCT No.: PCT/US2015/017147

§ 371 Date: Sep. 20, 2016

Related U.S. Application Data
(60) Provisional application No. 61/943,172, filed on Feb. 21, 2014.
(60) Provisional application No. 62/058,193, filed on Oct. 1, 2014.

(51) Int. Cl. A23C 20/02

(52) U.S. Cl. CPC A23C 20/025; A23Y 2240/75

(57) ABSTRACT

A soy-based cheese is described that includes microbial cultures or acid. The soy-based cheese is meltable and can be sliced, grated or cubed and used in place of American process cheese. The soy-based cheese can be plant-based.

### CROSS-REFERENCE TO RELATED APPLICATIONS

This application claims priority to U.S. Provisional Application Ser. No. 61/943,172, filed Feb. 21, 2014, and U.S. Provisional Application Ser. No. 62/058,193 filed Oct. 1, 2014, which are incorporated herein by reference in their entirety.

### TECHNICAL FIELD

This invention relates to soy-based cheese, and more particularly to a soy-based cheese containing microbial cultures or acid.

### BACKGROUND

Cheese making has relied on dairy milks as the major ingredient for more than 4000 years. Dairy cheese is usually made from curds formed from dairy milk. Dairy milks can readily be made to form curds suitable for making cheese by contacting the dairy milk with rennet (an aspartic protease which cleaves kappa-casein) at mildly acidic pH. Some cheeses, e.g., cream cheese, cottage cheese and paneer, are made without rennet. In the absence of rennet, dairy cheese may be induced to curdle with acid (e.g., lemon juice, vinegar, etc.) or a combination of heat and acid. Acid coagulation can also occur naturally from starter culture fermentation. The strength of the curds depends on the type of coagulation. Most commercially produced cheeses use some type of rennet (animal, vegetable or microbial-derived) in their production. Commodity cheeses or “processed cheeses” such as bulk cheddar, food-service mozzarella pizza and “cheese products,” or “cheese foods” such as American cheese, American singles, Velveeta, and Cheese Whiz are typically produced from dairy-derived ingredients and other additives using industrial processes that little resemble traditional cheese making. A variety of non-dairy cheese analogs are available that contain soy products (e.g., soy milk powder, soy protein, or soy flour), oils, and various thickeners. However, the taste and texture of such products does not match that of dairy-based cheeses, and the amount of protein per serving is typically a third of that found in their dairy counterparts. Thus, there is a need in the art for an improved method and system for producing non-dairy cheeses.

### SUMMARY

In one aspect, this document features a soy-based cheese that includes soy milk; a microbial strain (e.g., a bacterial strain, a yeast strain, or a mold strain) or an acid (e.g., citric acid, lemon juice, HCl, pyruvic acid); a low methyl ester, amidated pectin; an oil; and optionally one or more of a salt, a starch, a sugar, a flavoring, an antioxidant, a coloring agent, a gum, an amino acid, quinoa, pyruvic acid or a salt form thereof, a preservative, coconut milk, coconut cream, yeast extract, a dried yeast, one or more proteins, lecithin (e.g., sunflower or soy lecithin), a flour, a fiber, or cellulose. The bacterial strain can be selected from the group consisting of Lactococcus lactis lactis (LLL), Lactococcus lactis cremoris (LLC), Lactococcus lactis biovar diacetylactis (LLBD), Staphylococcus xylosus (SX), and Streptococcus thermophilus (ST). The soy-based cheese can include two bacterial strains (e.g., ST and SX). The choice of microbial strain(s), and the specific culturing conditions (temperature, aeration, nutritional additives) impacts the flavor profile of the soy cheese. The oil can be canola oil, palm fruit oil, palm oil, palm stearin oil, olive oil, flaxseed oil, sunflower oil, coconut oil, soybean oil, cocoa butter, or a margarine containing a mixture of two or more oils. The soy-based cheeses described herein are meltable. In some embodiments, the soy-based cheese does not include agar-agar. In some embodiments, the soy-based cheese does not include cyanobacteria or Lactobacillus acidophilus. In some embodiments, the soy-based cheese does not include agar-agar, cyanobacteria, or Lactobacillus acidophilus. In some embodiments, the soy-based cheese can include an animal product, e.g., casein or other non-plant based material. In some embodiments, the soy-based cheese is a plant-based soy-based cheese, i.e., a soy-based cheese containing no animal products. Soy-based cheeses containing no animal products also can be referred to as vegan soy-based cheeses.

Any of the soy-based cheeses described herein can include a salt (e.g., sodium chloride).

Any of the soy-based cheeses described herein can include a starch. The starch can be potato starch, corn starch, tapioca, rice starch, pea starch, arrowroot starch, or a modified food starch. The potato starch can be an amylopectin potato starch.

Any of the soy-based cheeses described herein can include sugar (e.g., one or more of glucose, fructose, sucrose, maltose, ribose, xylose, and mannose). For example, the soy-based cheese can include glucose, fructose, and/or sucrose. In some embodiments, the sugar is cane sugar, cane juice, corn syrup, brown rice syrup, agave syrup, maple syrup, glycerin, inulin, or maltodextrin.

Any of the soy-based cheeses described herein can include a flavoring, either natural or artificial, to provide additional cheesy, buttery, and/or milky/dairy flavor notes, or other desired flavor to the cheese. The flavoring can be a flavoring compound that includes one or more of acetoin, 5,6-decenoic acid, butanoic acid, gamma-undecalactone, 2,3 butanedione, butyl butyryllactate, delta-decacalactone, delta-tetradecalactone, gamma-tetradecalactone, delta-hexadecalatone, gamma-decalactone, gamma-dodecalactone, delta-dodecalactone, delta-tridecalactone, gamma-hexalactone, hexanoic acid, decanoic acid, octanoic acid, 2-tridecanone, caprylic acid, cis-3-hexanol, dimethyl sulfide, furaneol, indole, methional, methyl amyl ketone, thiophenol, trans-2-hexanal, propionic acid, ethyl butyrate, ethyl caproate, ethyl caprylate, ethyl decanoate, ethyl laurate, ethyl myristate, ethyl oleate, ethyl heptanoate, stearic acid, ethyl palmitate, 2-butanol, 2-methyl-butanal, 3-methyl-butanal, isovaleric acid, guaiacol, pyrizines, butyl alcohol, phenylacetic acid, methyl mercaptan, an amino acid, coconut milk or coconut cream. In some embodiments, an amino acid is used, for example, to provide sweetness. In some embodiments, a combination of butanoic acid, 5,6 decenoic acid, and acetoin can be used. In some embodiments, a combination of coconut cream, butanoic acid, 2,3 butanedione, gamma-undecalactone, and acetoin can be used. In some embodiments, the flavoring is an herb, a spice, or a vegetable.

Any of the soy-based cheeses described herein can include an antioxidant (e.g., vitamin E or mixed tocopherols).

Any of the soy-based cheeses described herein can include a coloring agent. For example, the coloring agent can be annatto, apocarotenal, beta-carotene, paprika, vegetable juice, or turmeric.

Any of the soy-based cheeses described herein can include an amino acid (e.g., leucine, alanine, valine, tyrosine, phenylalanine, lysine, isoleucine, glutamic acid and/or glycine). In some embodiments, an amino acid is used, for example, to provide sweetness.

Any of the soy-based cheeses described herein can include a gum. For example, the gum can be carrageenan, xanthan, konjac, guar, gellan, locust bean, or gum arabic. For example, the gum can be guar gum.

Any of the soy-based cheeses described herein can include one or more proteins (e.g., a protein isolate such as soy protein isolate or the soluble portion of soy flour or soy protein isolate, an isolated protein, or a combination of proteins). The protein can be an isolated protein such as a lentil protein, a soy protein, or a pea protein. The isolated protein can be pea vicilin, pea legumin, soy β-conglycinin, soy glycinin, or a dehydrin protein. The term “isolated” indicates that the preparation of the protein is at least 60% pure, e.g., greater than 65%, 70%, 75%, 80%, 85%, 90%, 95%, or 99% pure. The protein content of a soy-based cheese can be up to 10% protein, up to 15% protein, or up to 19% protein. For example, the soy-based cheese can have 10% to 15% protein or 10% to 19% protein. In some embodiments, the soy-based cheese has a protein content of at least 10%, at least 15%, or at least 19%.

The protein content of a soy-based cheese can be similar to that of a dairy based American cheese. For example, the protein content of the soy-based cheese can be 15% to 20% (e.g., 16% to 19%).

The carboyhydrate content of a soy-based cheese can be less than that of a dairy based American cheese. For example, the carbohydrate content of the soy-based cheese can be 4% to 7%.

The fat content of a soy-based cheese can be less than that of a dairy based American cheese. For example, the fat content of the soy-based cheese can be from 16% to 22%.

Any of the soy-based cheeses described herein can include a preservative. For example the preservative can be sorbic acid, natamycin, “cultured dextrose,” or olive leaf extract.

In another aspect, this document features a method of making a soy-based cheese. The method includes incubating a mixture of (i) soy milk, (ii) an optional sugar and optional one or more proteins, and (iii) a microbial strain (e.g., a bacterial strain) or an acid for a period of time sufficient to reach a pH of 5.4 to 6.4 (e.g., 5.4 to 6.2, 5.4 to 5.7, 5.8 to 6.2, or 5.4 to 5.6); blending the mixture; adding to the blended mixture, a low methylester, amidated pectin, an oil, an optional salt, an optional starch, an optional preservative, and an optional coloring agent and blending; heating the mixture to a temperature from about 60° C. to about 100° C. (e.g., at least 65° C., at least 70° C., at least 80° C., at least 85° C., at least 90° C., 60° C. to 80° C., 65° C. to 85° C., 70° C. to 90° C., 75° C. to 99° C., 80° C. to 100° C., or 85° C. to 100° C.); and adding to the heated mixture, one or more optional sugars and one or more flavorings to produce the soy-based cheese. The coloring agent also can be added after the heating step, and the sugar can be optionally added before the heating step. The method further can include forming the soy-based cheese in a mold.

In yet another aspect, this document features a method of making a soy-based cheese. The method includes incubating a mixture of (i) soy milk, (ii) an optional sugar and optional one or more proteins, and (iii) a microbial strain (e.g., a bacterial strain) or an acid for a period of time sufficient to reach a pH of 5.4 to 5.7; heating the mixture to a temperature between 70° C. and 90° C.; separating the curd and whey in the heated mixture and optionally combining the curd:whey to obtain a ratio of 35:65 to 100:0 curd:whey (e.g., 60:40, 65:35, 70:30, or 75:25); adding to the curd:whey combination, a low methylester, amidated pectin, an oil, an optional salt, an optional starch, an optional sugar, an optional coloring agent, and optional preservative such as sorbic acid; cooking the mixture to a temperature between 80° C. and 95° C. with blending; adding one or more flavorings to the cooked mixture; and blending the cooked mixture to obtain the soy-based cheese. The method further can include forming the soy-based cheese in a mold.

The document also features a soy-based cheese that includes soy milk; an acid (e.g., citric acid, lemon juice, HCl, and pyruvic acid); a low methyl ester, amidated pectin; an oil; and optionally one or more of a salt, a starch, a sugar, a flavoring, an antioxidant, a coloring agent, a gum, an amino acid, quinoa, pyruvic acid or a salt form thereof, a preservative, lactic acid, acetic acid, yeast extract, a dried yeast, one or more proteins, lecithin, a flour, a fiber, or cellulose.

In another aspect, this document features a soy-based cheese that includes soy milk; a microbial strain; a low methyl ester, amidated pectin; one or more proteins; an oil; a sugar (glucose, fructose, and/or sucrose); a gum (e.g., carrageenan, xanthan, konjac, guar gum, gellan, locust bean, or gum Arabic); a coloring agent (e.g., annatto, apocarotenal, beta-carotene, paprika, vegetable juice, or turmeric); and a flavoring. The soy-based cheese further can include a salt such as sodium chloride or a preservative such as sorbic acid, natamycin, cultured dextrose, olive leaf extract or a mixture thereof. The one or more proteins can include soy protein isolate or the soluble proteins from soy flour or soy protein isolate, or an isolated protein (e.g., a lentil protein, a soy protein, or a pea protein). For example, the protein can be pea vicilin, pea legumin, soy β-conglycinin, soy glycinin, or a dehydrin protein. The protein content of a soy-based cheese can be up to 10% protein, up to 15% protein, or up to 19% protein. For example, the soy-based cheese can have 10% to 15% protein or 10% to 19% protein. In some embodiments, the soy-based cheese has a protein content of at least 10%, at least 15%, or at least 19%. The protein content of a soy-based cheese can be similar to that of a dairy based American cheese. For example, the protein content of the soy-based cheese can be 15% to 20% (e.g., 16% to 19%). The carboyhydrate content of a soy-based cheese can be less than that of a dairy based American cheese. For example, the carbohydrate content of the soy-based cheese can be 4% to 7%. The fat content of a soy-based cheese can be less than that of a dairy based American cheese. For example, the fat content of the soy-based cheese can be from 16% to 22%. The soy-based cheese can be meltable. The soy-based cheese can be plant-based.

In another aspect, this document features a soy-based cheese that includes soy milk; a low methyl ester, amidated pectin; one or more proteins; an oil, and optionally one or more of a salt, a starch, a sugar, a flavoring, an antioxidant, a coloring agent, a gum, an amino acid, quinoa, pyruvic acid or a salt form thereof, a preservative, lactic acid, acetic acid, yeast extract, a dried yeast, one or more proteins, lecithin, a flour, a fiber, or cellulose. The one or more proteins can include soy protein isolate or the soluble proteins from soy flour or soy protein isolate, or an isolated protein (e.g., a lentil protein, a soy protein, or a pea protein). For example, the protein can be pea vicilin, pea legumin, soy β-conglycinin, soy glycinin, or a dehydrin protein. The protein content of a soy-based cheese can be up to 10% protein, up to 15% protein, or up to 19% protein. For example, the soy-based cheese can have 10% to 15% protein or 10% to 19% protein. In some embodiments, the soy-based cheese has a protein content of at least 10%, at least 15%, or at least 19%. The protein content of a soy-based cheese can be similar to that of a dairy based American cheese. For example, the protein content of the soy-based cheese can be 15% to 20% (e.g., 16% to 19%). The carboyhydrate content of a soy-based cheese can be less than that of a dairy based American cheese. For example, the carbohydrate content of the soy-based cheese can be 4% to 7%. The fat content of a soy-based cheese can be less than that of a dairy based American cheese. For example, the fat content of the soy-based cheese can be from 16% to 22%. The soy-based cheese can be meltable. The soy-based cheese can be plant-based.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims. The word “comprising” in the claims may be replaced by “consisting essentially of” or with “consisting of,” according to standard practice in patent law.

### DESCRIPTION OF DRAWINGS

FIG. 1 is a representative photograph of soy-based cheese after melting at 325° F. for five minutes.

FIG. 2 is a representative photograph of soy-based cheese produced using the method of Example 2.

FIG. 3 is a representative photograph of the soy-based cheese produced in Example 3.

FIG. 4 is a representative photograph of a sliced block of soy-based cheese produced in Example 3.

FIG. 5 is a representative photograph of the cheese after grating in a Cuisinart food processor a few minutes after removal from refrigerator.

FIG. 6 is a representative photograph of a grilled cheese sandwich made with the soy-based cheese of Example 4.

FIG. 7 is a representative photograph showing the meltability of the soy-based cheese prepared in Example 7 with the soluble protein pellet (SPP) from soy flour. The left panel shows a 2 g sample of cheese prior to heating. The right panel shows that the cheese melted at 70° C.

### DETAILED DESCRIPTION

In general, this document provides methods and materials for producing meltable soy-based cheeses, i.e., the soy-based cheeses are able to become liquefied with heating. Broadly, the document provides methods for making soy based cheeses by incubating soy milk with one or more microbial strains (e.g., bacterial, yeast or mold strains) or acids, and optionally, a sugar (e.g., glucose or other sugar), one or more proteins (e.g., one or more isolated proteins, a protein isolate such as soy protein isolate, or the soluble portion of soy flour or soy protein isolate (referred to as the soluble protein pellet)) and/or flavor enhancers such as yeast extract or calcium pyruvate, for a sufficient period of time to obtain the desired pH, which can range from about 4.5 to 6.4 (e.g., pH 5.4 to 5.7, 5.5 to 5.6, or 5.8 to 6.2). The length of the incubation period may vary depending on the temperature in which the soy milk and cultures are maintained. For example, the soy milk, microbial cultures, and optional ingredients can be incubated at temperatures ranging from room temperature (e.g., approximately 25° C.) up to about 40° C. (e.g., 25° C.-37° C. or 25° C.-40° C.). It will be appreciated that the incubation time may vary depending on the size of the batch, amount of inoculum, and culture temperature.

Once the desired pH is reached, the resulting mixture of curds and whey (i.e., the liquid remaining after curdling) can be processed (e.g., by high speed shearing or blending to integrate the flavors, resulting in a soy based cheese with a mellower flavor) and one or more additional ingredients (e.g., oil, low methylester, amidated pectin such as pectin NH, and optional salts, starches, gums, coloring agents, sugars, flavorings, antioxidants, amino acids, quinoa, pyruvic acid or a salt form thereof, preservative, coconut milk, coconut cream, yeast extract, a dried yeast, protein, lecithin, a flour, a fiber, or cellulose) can be added. For example, the oil, salt, pectin, and coloring agent can be added to the blended mixture and the mixture heated to a temperature of about 60° C. to about 100° C. (e.g., at least 65° C., at least 70° C., at least 80° C., at least 85° C., at least 90° C., 60° C. to 80° C., 65° C. to 85° C., 70° C. to 90° C., 75° C. to 99° C., 80° C. to 100° C., or 85° C. to 100° C.). One or more sugars and one or more flavorings then can be added to produce the soy-based cheese. Cheese molds can be used to form the soy-based cheese to the desired shape.

In some embodiments, the curds and whey can be separated and the individual components processed. For example, the curds and whey can be separated by draining the whey from the curd. For example, the mixture of curds and whey can be heated (e.g., 70° C. to 90° C., 75° C., 80° C., or 85° C.) to aid the separation of the curd from the whey and to reduce the number of viable microorganisms. The curds and whey can be combined in various ratios ranging from 50:50 curd:whey to 80:20 curd:whey (e.g., 60% curd:40% whey; 65% curd:35% whey; 70% curd:30% whey, or 75% curd:25% whey). In some embodiments, the curd may be combined with water instead of whey.

A low methylester, amidated (LMA) pectin, an oil, and one or more optional ingredients (e.g., a salt, a starch, sugar, coloring agent, and/or a preservative such as sorbic acid) can be added to the curd:whey combination and the resulting mixture cooked to a temperature between 60° C. and 100° C. (e.g., at least 65° C., at least 70° C., at least 80° C., at least 85° C., at least 90° C., 60° C. to 80° C., 65° C. to 85° C., 70° C. to 90° C., 75° C. to 99° C., 80° C. to 100° C., or 85° C. to 100° C.) with blending. One or more flavorings can be added to the cooked mixture then blended to obtain the soy-based cheese. Cheese molds can be used to form the soy-based cheese to the desired shape.

As described herein, the color, texture, and/or flavor of the soy-based cheese is similar to American process cheese and has similar melting characteristics and gooeyness, as well as a similar dairy character (e.g., buttery, cheesy, and milky). The soy-based cheese can be sliced, grated or cubed, and used, for example, to create grilled soy-cheese sandwiches, soy-cheese sauce (e.g., for macaroni and cheese), nachos, and/or soy-cheese burgers.

In some embodiments, soy protein isolate is used as the optional protein source when making the soy-based cheese. Soy protein isolate refers to the proteins extracted from defatted soy flour and is commercially available from many sources. In some embodiments, insoluble material (e.g., insoluble proteins or other insoluble material) is removed from soy flour or soy protein isolate, and the remaining soluble portion of the soy flour or soy protein isolate is used to prepare the soy-based cheese replica. Removing the insoluble material before making the soy-based cheese replica improves the appearance (including both color and texture) as well as improves the mouth-feel of the soy-based cheese.

In embodiments in which the optional proteins are used in making the soy-based cheese, the protein content can be similar or more than that of a dairy based American cheese single. In some embodiments, the soy-based cheese can have a protein content that is similar or more than that of a dairy based American cheese (e.g., a block of dairy based American cheese or a dairy based American cheese single), and can have a carbohydrate content and/or a fat content that is similar or less than that of a dairy based American cheese (e.g., a block of dairy based American cheese or a dairy based American cheese single). For example, a soy-based cheese can have a protein content that is similar or higher than that of a dairy based American cheese, with a fat content that is less than that of a dairy based American cheese and a carbohydrate content that is similar to that of a dairy based American cheese. For example, a soy-based cheese can have a protein content that is similar or higher than that of a dairy based American cheese, with a carbohydrate content that is less than that of a dairy based American cheese and a fat content that is similar to that of a dairy based American cheese. For example, a soy-based cheese can have a protein content that is similar or higher than that of a dairy based American cheese, with a carbohydrate content and a fat content that is less than that of a dairy based American cheese. Typically, a dairy based cheese has a protein content of 18%, a carbohydrate content of 8%, and a fat content of 23%. For example, a soy-based cheese can have a protein content between 10% and 20% such as 10% and 19%, 10% to 15%, 15% to 20%, 15% to 19%, 15%, 16%, 17%, 18%, 19%, or 20%. For example, the soy-based cheese can have a carbohydrate content between 4% and 8% (e.g., 4% to 7%, 5% to 6%, 4%, 5%, 6%, or 7%). For example, the soy-based cheese can have a fat content between 16% and 23% (e.g., 16% to 18%, 19% to 22%, or 20% to 22%).

The invention will be further described in the following examples, which do not limit the scope of the invention described in the claims.

### EXAMPLES

### Example 1

A meltable soy-based cheese was prepared using the following ingredients:
a) soy milk composed of soybeans and water (no other additives)
b) glucose
c) bacterial cultures: strains Streptococcus thermophilus (ST) (as TA61, a commercial mix) and Staphylococcus xylosus (SX)
d) pectin (pectin NH)
e) potato starch
f) salt
g) canola oil
h) fructose
i) annatto
j) natural flavor

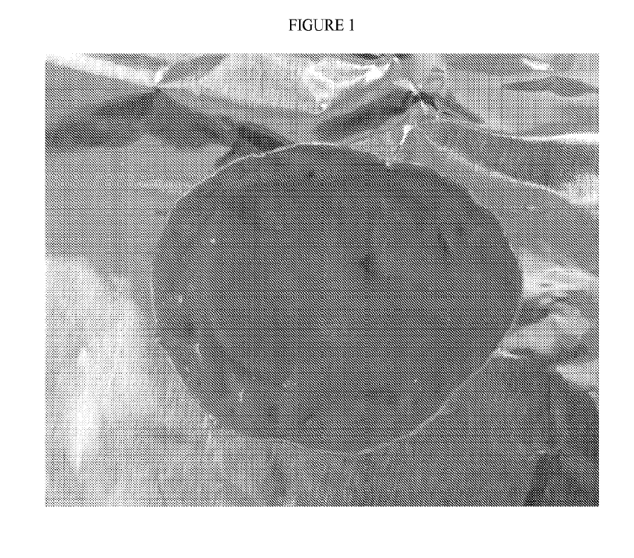

One liter of soy milk (SunOpta organic soy base) was heated to 30° C. in a clean sanitized container, and glucose was added to 50 mM (0.9%) along with cultures of SX and ST (each at a starting cell density of 1.25×10⁷ cfu/ml). The mixture was incubated until a pH of 5.5+/−0.1 was reached. The incubation typically takes 3-6 hours to reach the target pH. (At this point, the coagulated soy milk can be placed on ice and refrigerated for up to 24 hours, before proceeding. pH may drop a few tenths of a percent during this time.) The mixture was transferred to a food processor and sheared/blended for 3 minutes, then pectin NH at 3.2%, potato starch (Eliane 100) at 0.4%, salt at 1.4%, canola oil at 14%, and annatto at 0.08% (or as needed to achieve desired orange color) was added and the mixture blended again in the food processor for an additional 2 minutes. After blending, the mixture was transferred to a pot and boiled for about 2 minutes per each 200 ml volume. This step allows the pectin NH to dissolve and also acts as a “kill step” to reduce the inoculated bacterial count. The pot was removed from the heat, and 0.09% fructose and 0.18% glucose (for added sweetness) was whisked into the mixture. At this point, due to evaporation during boiling, the volume of the mixture is about 70% of the starting volume. The mixture was transferred to a food processor and cooled to about 70° C., and then coconut cream at 10%, butanoic acid in oil at 0.01%, 2,3 butanedione in oil at 0.0003%, gamma-undecalactone in oil at 0.00003%, and acetoin in water at 0.015% was added and the mixture blended for an additional minute to incorporate flavors into the mixture. Other combinations of natural flavors and/or artificial also can be used to flavor the cheese. The blended mixture was poured into cheese molds, and immediately covered with a plastic lid or wrap. The molds were refrigerated overnight to several days then removed. Once removed from the molds, the soy-based cheese can be sliced, grated or cubed, and used, for example, to create grilled soy-cheese sandwiches, soy-cheese sauce, and/or soy-cheese burgers. As shown in FIG. 1, the soy-based cheese is meltable (325° F.×5 minutes).

### Example 2

A soy-based cheese was prepared using the following ingredients:
a) soy milk, composed of soybeans and water (no other additives)
b) glucose
c) bacterial cultures: strains ST (as TA61, a commercial mix) and SX
d) LMA pectin (pectin NH)
e) potato starch
f) salt
g) canola oil
h) fructose
i) annatto
j) natural and artificial flavors
k) sorbic acid (or other preservative):

Fifteen (15) liters (L) of soy milk (SunOpta organic soy base) was heated to 30° C. in two clean sanitized pots of 7.5 L each, in a heated water bath, and glucose was added to 50 mM (0.9%) along with cultures of SX and ST (each at a starting cell density of 1.25×10⁷ cfu/ml). The mixture was incubated until a pH of 5.5+/−0.1 was reached. The incubation typically takes 3-6 hours to reach the target pH. Once the desired pH was reached, the pots were transferred to a double boiler set-up, and heated until the soy-milk mixture reached 75° C. After holding at 75° C. for one minute, the pots were removed from the heat source. The heating serves as a “kill step” (allowing us to maintain the mixture in the refrigerator for at least one week) and aids in the separation of curd from whey. The mixture was transferred to cheese-draining bags, and the curd was allowed to separate from the whey until a 70:30 curd:whey ratio was achieved. The 70:30 curd/whey mixture can be stored covered in the refrigerator for up to one week.

A 10-lb (4,5-kg) cooker run was performed by blending the curd/whey mixture at ˜75%, pectin NH at 3.2%, potato starch (Eliane 100) at 0.4%, salt at 1.4%, canola oil at 14%, annatto at 0.08% or as needed to achieve desired orange color, glucose at 0.18%, fructose at 0.09%, and sorbic acid at 0.2% (optional, as a preservative) in a mixer (alternatively a food processor) until well-blended and smooth. The blending step can be up to 30 minutes in length. The entire mixture was transferred to a pre-heated steam-cleaned chamber of a 10-pound cheese cooker and the temperature brought up to 180° C. by steam injection, with continuous mixing. The mixture was cooked for 4 minutes. The steam was turned off and flavors were added as follows (at the final concentrations shown): butanoic acid in oil at 0.01%, 5,6 decenoic acid in oil at 0.005%, and acetoin in water at 0.015%. The butanoic acid and 5,6 decenoic acid were added together in a 5-ml volume of canola oil, and the acetoin is in 11.2 ml of water. The cooker was run for an additional minute without steam injection. Note that the steam injection contributes an additional ˜5% water (or about 225 ml per 4.5-kg batch) to the mixture.

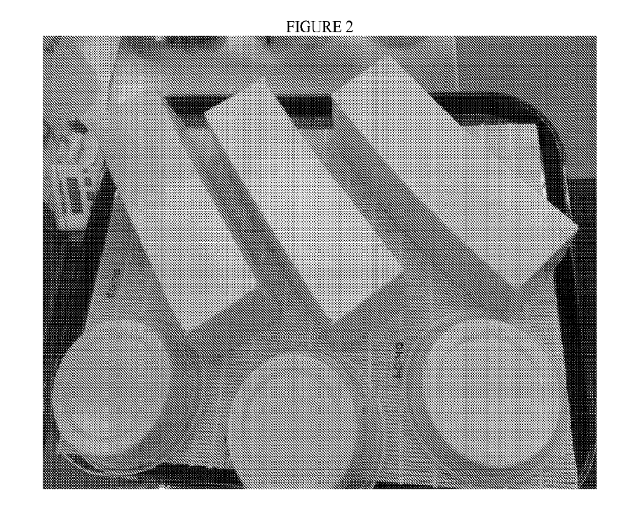

The cooked soy-cheese mixture was decanted and transferred to a mixer (e.g., KitchenAid), and sheared/blended at high speed for 5 minutes. This post-cooking blending step helps prevent syneresis of oil. The blended mixture was poured into cheese molds, and immediately covered with a plastic lid or wrap. The molds were refrigerated overnight to several days, then removed. FIG. 2 contains a photograph of the soy-based cheese. Once removed from the molds, the soy-based cheese can be sliced, grated or cubed, and used, for example, to create grilled soy-cheese sandwiches, soy-cheese sauce, and/or soy-cheese burgers.

### Example 3

A soy-based cheese was prepared using the ingredients in Example 1, with the following additions: calcium pyruvate, yeast extract, Earth Balance buttery spread, glycine, and mixed tocopherols. The presence of calcium pyruvate contributes to a milder, less sour cheese replica. Yeast extract promotes bacterial strain growth and contributes some savory flavor to the cheese replica. Glycine may reduce sourness in the soy cheese.

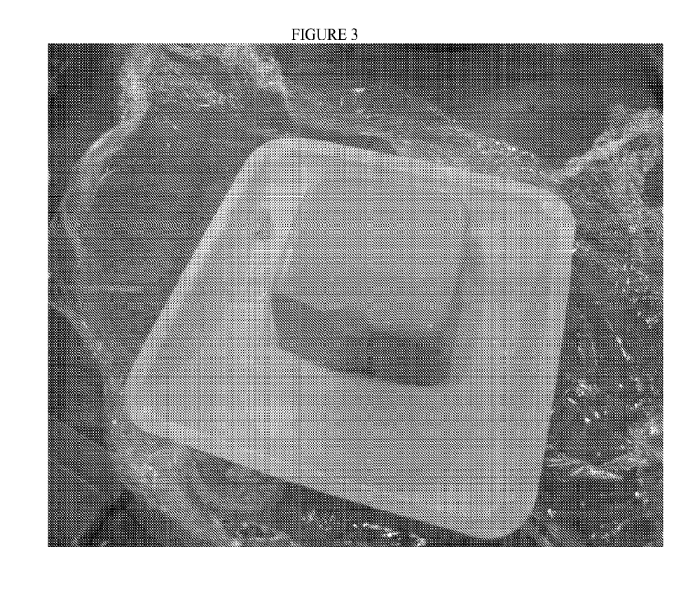

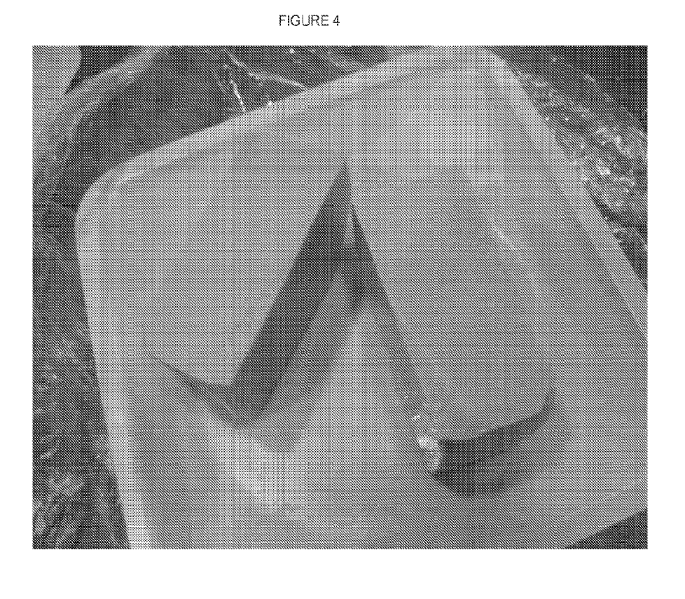

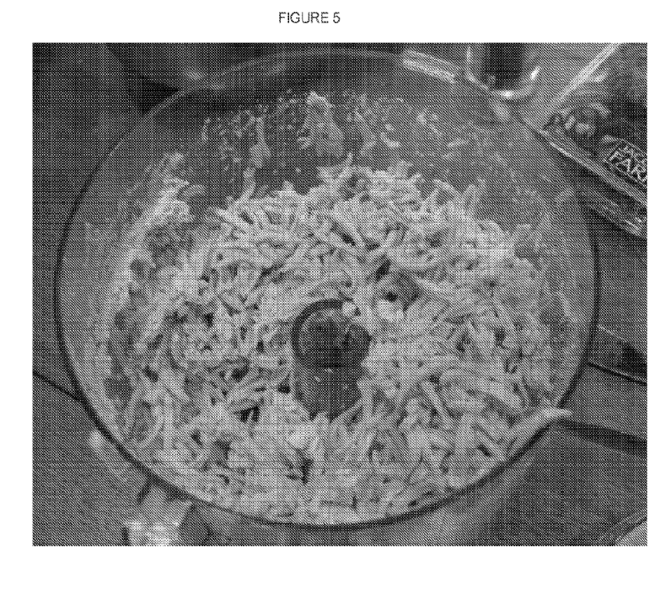

The soy cheese was prepared as described in Example 1, with the calcium pyruvate (˜pH 2) added to 10 mM final concentration and yeast extract added at 0.5%, at the same time the cultures were added. After the mixture reached the desired pH, the pectin NH at 3.2%, potato starch (Eliane 100) at 0.4%, salt at 1.3%, canola oil at 7%, and annatto at 0.2% (or as needed to achieve desired orange color), glucose at 10 mM, and glycine at 5 mM was added. After pulsing 10 times to mix in a mini-chopper, the mixture was blended for 1 minute, then transferred to a pot. The mixture was boiled for 2 minutes, and then the following ingredients were added: Earth Balance buttery spread at 7% and mixed tocopherols at 0.5% (0.75 mg in canola oil per 150 ml mixture). The mixture was whisked until blended and smooth, and then immediately poured into cheese molds, and covered in plastic wrap and refrigerated overnight. The soy-based cheeses were un-molded and transferred to plastic containers and wrapped in plastic wrap (FIG. 3) and returned to the refrigerator until used. The cheeses were smooth and shiny when unwrapped, and had a dairy cheesy aroma. The cheese replicas were sliced (FIG. 4), and shredded in a Cuisinart (FIG. 5).

### Example 4

A meltable plant-based soy based cheese was prepared using the following ingredients:
a) soy milk, composed of soybeans and water (no other additives)
b) soy protein isolate (Supro XT 219D, Solae)
c) glucose
d) bacterial cultures: strains Streptococcus thermophilus (ST) (as TA61, a commercial mix) and Staphylococcus xylosus (SX)
e) LMA pectin (pectin NH)
f) potato starch
g) salt
h) coconut oil
i) coconut cream
j) guar gum
k) fructose
l) annatto
m) natural flavors

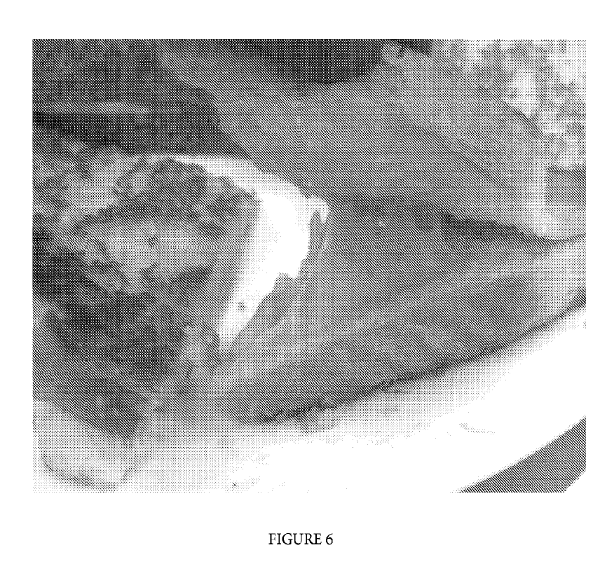

Soy milk (SunOpta organic soy base) was heated to 30° C. in a clean sanitized container. Soy protein isolate (Supra XT 219D) was added at 15%, glucose was added to 50 mM (0.9%), and cultures of SX and ST were each added at a starting cell density of approximately 1.25×10⁷ cfu/ml. The mixture was incubated until a pH of approximately 5.6 was reached. The incubation typically takes 3-6 hours to reach the target pH. (At this point, the coagulated soy milk can be placed on ice and refrigerated for up to 24 hours, before proceeding. pH may drop a few tenths of a percent during this time.) The mixture was transferred to a food processor and sheared/blended for 1 minute, then coconut cream (Kara, 5%), coconut oil (Shay and Co., 15%) and annatto (0.1-0.2%) were added, and the mixture was pulsed to thoroughly blend. Next, Pectin NH at 3.2%, potato starch (Eliane 100) at 0.4%, salt at 1.4%, guar gum at 0.3%, glucose at 0.2% and fructose at 0.1% were added and the mixture blended again in the food processor for an additional 2 minutes. (Note: guar gum also may be pre-hydrated in water prior to blending.) After blending, the mixture was transferred to a pot and boiled for about 2 minutes per each 200 ml volume, to achieve an approximate weight loss of 15% due to water evaporation. This step allows the pectin to dissolve and also acts as a “kill step” to reduce the inoculated bacterial count. The pot was removed from the heat, and its contents were transferred to a mixer. Flavors were added: butanoic acid in oil at 0.01%, 2,3 butanedione in oil at 0.0003%, gamma-undecalactone in oil at 0.00003%, and acetoin in water at 0.015%, and the mixture blended for 30 seconds to incorporate these flavors into the mixture. The blended mixture was poured into cheese molds, and immediately covered with plastic wrap. The molds were refrigerated overnight to several days. Once removed from the molds, the soy-based cheese can be sliced, grated or cubed, and used, for example, to create grilled soy-cheese sandwiches, soy-cheese sauce, and/or soy-cheese burgers. The protein content of the soy-based cheese (analysis by Silliker) was about 15-16%. Soy-based cheese prepared with added soy-protein isolate and guar gum has a more cohesive and gooey melt than otherwise comparable soy-based cheese prepared without added soy protein isolate or guar gum. FIG. 6 provides a representative photograph of a grilled cheese prepared with the soy based cheese of this example.

### Example 5

A meltable plant-based soy-based cheese with a protein content that matches that of dairy American cheese was prepared using the following ingredients:
a) soy milk, composed of soybeans and water (no other additives)
b) soy protein isolate (Supro XT 219D, Solae)
c) glucose
d) bacterial cultures: strains Streptococcus thermophilus (ST) (as TA61, a commercial mix) and Staphylococcus xylosus (SX)
e) LMA pectin (pectin NH)
f) salt
g) coconut oil
h) canola oil
i) coconut milk
j) guar gum
k) sucrose
l) annatto
m) natural and/or artificial flavors

Soy milk (SunOpta organic soy base) was heated to 30° C. in a clean sanitized container. Soy protein isolate (Supro XI 219D) was added at 23%, glucose was added to 50 mM (0.9%), and cultures of SX and ST were each added at a starting cell density of approximately 1.25×10⁷ cfu/ml. The mixture was incubated until a pH of approximately 6.2 was reached. The incubation typically takes 3-4 hours to reach the target pH. The mixture was transferred to a food processor. The Mowing ingredients were added, and the mixture was sheared/blended for 3 minutes: coconut milk (5%), coconut oil (14%), canola oil (4%), pectin NH (3.2%), salt (1.4%), guar gum (0.01%), and sucrose (0.9%). After blending, the mixture was transferred to a pan set atop a pot of boiling water and heated until the mixture reached 80° C., and achieved an approximate weight loss of 4%±1% due to water evaporation. This step allows the pectin to dissolve and also acts as a “kill step” to reduce the inoculated bacterial count. (If moisture loss exceeds 5%, water may be added back to the mixture to achieve a final moisture loss of about 4%) The pot was removed from the heat, and its contents were transferred to a mixer. Flavors were added, followed by annatto (67% solution at 0.1%) and the mixture was blended for 3 minutes. The blended mixture was poured into cheese molds, and immediately covered with plastic wrap. The molds were refrigerated overnight to several days. Once removed from the molds, the soy-based cheese can be sliced, grated or cubed, and used, for example, to create grilled soy-cheese sandwiches, soy-cheese sauce, and/or soy cheese burgers. The protein content of the soy-based cheese is comparable to that of a dairy-based American cheese, Kraft American singles, but with slightly lower fat (and no cholesterol) and carbohydrates (see Table 1, nutritional analysis by Silliker Inc. for the dairy based cheese).

TABLE 1

| Sample | % protein | % fat | % carbohydrates |
|---|---|---|---|
| Kraft American | 18 | 23 | 8 |
| singles cheese | | | |
| soy-based cheese | 18 | 22 | 6 |
| from Example 5 | | | |

### Example 6

A soy-based cheese replica was prepared with the following ingredients:
a) soy milk composed of soybeans and water (no other additives)
b) glucose
c) bacterial cultures: strains Streptococcus thermophilus (ST) (as TA61, a commercial mix) and Staphylococcus xylosus (SX)
d) LMA pectin (pectin NH)
e) potato starch
f) salt
g) coconut oil
h) coconut cream
i) guar gum
j) fructose
k) annatto
l) natural flavors

Soy milk (SunOpta organic soy base) was heated to 30° C. in a clean sanitized container. Glucose was added to 50 ml (0.9%), and cultures of ST and SX were each added at a starting cell density of approximately 1.25×10⁷ cfu/ml. The mixture was incubated until a pH of approximately 5.5 was reached. The mixture was transferred to a food processor. The following ingredients were added, and the mixture was sheared/blended for 2 minutes: coconut cream (10%), coconut oil (16.4%), Pectin NH (3.2%), potato starch (Eliane 100) (0.4%), salt (1.4%), guar gum (0.1%), and annatto (0.2% of a 67% solution in water). After blending, the mixture was transferred to a pot and boiled for about 2 minutes per each 200 ml volume, with continuous whisking. This step allows the LMA pectin to dissolve, reduces the moisture content, and also acts as a “kill step” to reduce the inoculated bacterial count. The pot was removed from the heat, and its contents transferred to a blender. 0.09% fructose, 0.18% glucose and 0.33% natural flavors were added, and the mixture was sheared/blended for 1 minute. The blended mixture was poured into cheese molds, and immediately covered with plastic wrap. The molds were refrigerated overnight to several days.

Once removed from the molds, the soy-based cheese replica was sliced, packaged in plastic containers and shipped on ice, along with packages of Tofutti American soy cheese slices (ingredients: water, may contain one or more of the following oils: soy, corn or palm, non-GMO [tofu, soy protein), carrageenan, maltodextrin, vinegar, corn starch, calcium phosphate, potato flakes, salt, potassium phosphate, non-dairy lactic acid, adipic acid, soya, natural colors and potassium sorbate (added as a preservative)] to the sensory test site. 98 subjects were served the two sliced samples in random order, and then the two samples in the form of grilled cheese sandwiches (GC) in random order. A 9-point degree of liking (DOL) scale was used to rate the samples for overall liking, appearance, flavor and texture. A 5-point DOL scale was used to rate purchase intent.

As shown in Tables 2A and 2B, the soy-based American cheese replica (Test sample) was preferred to Tofutti when the two samples were compared as slices or as GC sandwiches. There was a significant difference (p<0.05) between the samples in DOL on overall liking (Test GC was rated higher than Tofutti GC and Test Single was rated higher than Tofutti Single), appearance (Test GC was rated higher Tofutti GC), flavor (Test GC was rated higher than Tofutti GC and Test Single was rated higher than Tofutti Single), texture (Test GC was rated higher than Tofutti GC and Test Single was rated higher than Tofutti Single) and purchase intent (Test GC was rated higher than Tofutti GC and Test Single was rated higher than Tofutti Single). The only non-significant difference between slices was for appearance.

TABLE 2a
Mean scores for comparison of single slices

| | Test mean: | Tofutti mean: |
|---|---|---|
| Attribute | slice | slice |
| Overall liking | 4.92 | 3.63 |
| Appearance | 5.72 | 5.88 |
| Flavor | 5.09 | 3.20 |
| Texture | 4.74 | 3.98 |
| Purchase Intent | 2.13 | 1.49 |

TABLE 2b
Mean scores for comparison of grilled cheese sandwiches

| | Test mean: | Tofutti mean: |
|---|---|---|
| Attribute | GC | GC |
| Overall liking | 6.21 | 4.73 |
| Appearance | 6.53 | 5.50 |
| Flavor | 6.00 | 4.52 |
| Texture | 6.28 | 4.87 |
| Purchase Intent | 2.95 | 2.00 |

### Example 7

A meltable soy-based cheese was prepared using the following ingredients:
a) soy milk composed of soybeans and water (no other additives)
b) soluble soy protein, isolated from CHS HoneySoy flour
c) glucose
d) bacterial cultures: strains Streptococcus thermophilus (ST) (as TA61, a commercial mix) and Staphylococcus xylosus (SX)
e) LMA pectin
f) salt
g) sucrose
h) coconut oil
i) coconut cream
j) guar gum
k) annatto
l) natural & artificial flavors

Soluble soy protein was isolated from CHS Honeysoy flour using acid precipitation. Soy flour was suspended in water at a 1:5 ratio. The pH of the mixture was adjusted to pH 8.0 using 2 N NaOH. The protein slurry was stirred for 1 hour at 4° C. The insoluble starch and protein were removed using centrifugation at 15,000×g at 19° C. for 15 minutes. The insolubles (pellet) were discarded and the pH of the supernatant was adjusted to pH 4.5 using 2 M H₂SO₄ to precipitate out the soluble protein. The supernatant was stirred for 1 hour at 4° C., A second centrifugation (15,000×g, 19° C., 15 minutes) separated the soluble protein (pellet) from solution. The pellet was stored at 4° C. until further use.

To prepare the soy-based cheese using the soluble protein pellet (SPP), the wet SPP (33.50%) recovered from the protein extraction was slowly added to soymilk (64.60%). Due to the large pH differences between the protein pellet (pH 4.5) and soy-milk (pH 6.76) the pH was maintained between 6.0-6.8 using 2 M NaOH. An immersion blender was used to ensure a homogeneous mixture. The final pH of the mixture was 6.85. The mixture was stored overnight. The following day the pH was re-adjusted to pH 6.85 using 2N NaOH. The mixture was heated to 30° C. in a water bath. Glucose (0.90%) was added, followed by the bacterial cultures (˜1.0%, starting cell density of 1.25×10⁷ cfu/ml each for SX and ST). The mixture was incubated at 30-35° C. until the pH reached 5.95, approximately 4 hours. The mixture was immediately put on ice to slow the microbial growth and maintain pH, and stored overnight at 4° C.

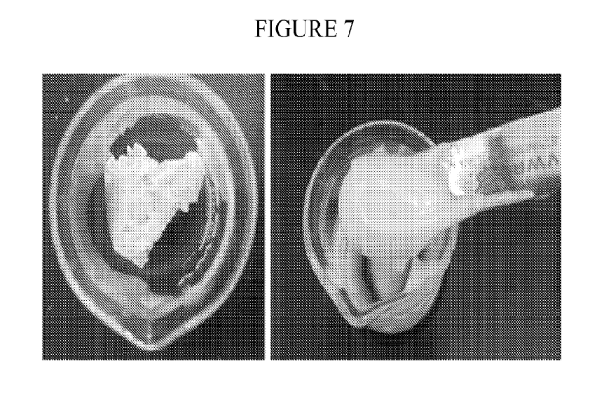

The mixture then was added to a food processor and sheared for 1 minute. The dry ingredients (LMA pectin (3.20%), guar gum (0.10%), salt (1.40%) and sucrose (0.9%) were added and the mixture was sheared for 1 minute. The wet ingredients, coconut oil (13.0%) and coconut cream (5.00%), were added and the mixture was sheared for an additional minute or until all ingredients were well incorporated. The mixture was heated over a double broiler until the temperature of the mixture reached 80° C. The hot mixture was then returned to a clean food processor and sheared for 30 seconds. The natural and artificial flavors (2.63 μL/g of cheese) were added and the mixture was sheared for 1 minute. Finally the annatto (0.10%) was added and the mixture was sheared until the color was uniform, approximately 1 minute. The mixture then was poured into molds, covered and stored at 4° C. This soy-based cheese was meltable after heating to 70° C. as demonstrated in FIG. 7.

The color of the soy-based cheese prepared with SPP was brighter, shinier, and closer in color to dairy American cheese (e.g., Kraft singles) than soy-based cheese prepared with soy protein isolate (SPI). Colorimetry confirmed that the sample made with SPP was brighter (L*=71.96) and closer to Kraft (L*=74.83) than the control (L*=67.73), where L* of 0=darkest black and L* of 100=brightest white. A tasting of the two soy-based cheeses in the form of grilled cheese sandwiches demonstrated that using SPP instead of SPI yields a smoother, creamier mouthfeel.

### Example 8

Soy milk (SunOpta organic soy base) was heated to 30° C. in a clean sanitized container. Soy protein isolate (Supro XT 219D) was added at 18% and glucose was added at 0.9%. A sample was removed for gas chromatography mass spectrometry (GCMS) analysis of the volatile flavor compounds present in the starting material, which was ˜pH 7.0. Cultures of SX and ST were each added at a starting cell density of approximately 1.25×10⁷ cfu/ml. The mixture was incubated at 30° C. and samples were removed at various points for GCMS analysis including at pH 6.5, 6.2, 6.0, and 5.8, and after overnight incubation.

The GCMS data indicated that several dairy aroma compounds were created during the soy mixture fermentation, including acetoin, propanoic acid, 3-methyl-butanal, acetic acid, butanoic acid, and hexanoic acid. The signal intensity of each of acetoin, propanoic acid, 3-methyl-butanal, acetic acid, and hexanoic acid was similar to that found in a dairy American cheese (Kraft American singles). See Table 3.

TABLE 3
GCMS signal intensity of volatile flavor compounds

| | Kraft American | Fermented soy |
|---|---|---|
| Compound | singles | mixture, pH 5.8 |
| Acetoin (sweet, buttery, | 2.36E+08 | 4.29E+08 |
| creamy, dairy, milky, | | |
| fatty) | | |
| Propanoic acid (pungent, | 3.48E+04 | 9.00E+05 |
| acidic, cheesy, vinegar) | | |
| 3-methyl-butanal | 8.99E+06 | 2.28E+07 |
| (ethereal, aldehydic, | | |
| chocolate, peachy, fatty) | | |
| Acetic acid (sharp, | 1.22E+08 | 8.98E+07 |
| pungent, sour, vinegar) | | |
| Hexanoic acid (sour, | 2.44E+07 | 1.68E+07 |
| fatty, sweat, cheese) | | |

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A soy-based cheese comprising:
a) soy milk;
b) a microbial strain;
c) a low methyl ester, amidated pectin;
d) an oil; and
e) optionally one or more of a salt, a starch, a sugar, a flavoring, an antioxidant, a coloring agent, a gum, an amino acid, quinoa, pyruvic acid or a salt form thereof, a preservative, lactic acid, acetic acid, coconut milk, coconut cream, yeast extract, a dried yeast, one or more proteins, lecithin, a flour, a fiber, or cellulose.

2. The soy-based cheese of claim 1, wherein said microbial strain is a bacterial strain, a yeast strain, or a mold strain.

3. The soy-based cheese of claim 2, wherein said bacterial strain is selected from the group consisting of Lactococcus lactis lactis (LLL), Lactococcus lactis cremoris (LLC), Lactococcus lactis biovar diacetylactis (LLBD), Staphylococcus xylosus (SX), and Streptococcus thermophilus (ST).

4. The soy-based cheese of claim 3, said soy-based cheese comprising two bacterial strains.

5. The soy-based cheese of claim 4, wherein said bacterial strains are ST and SX.

6. The soy-based cheese of any one of claims 1-5, said soy-based cheese comprising said starch.

7. The soy-based cheese of claim 6, wherein said starch is potato starch, corn starch, tapioca, rice starch, pea starch, arrowroot starch, or a modified food starch.

8. The soy-based cheese of any one of claims 1-7, wherein said oil is canola oil, palm fruit oil, palm oil, palm stearin oil, olive oil, flaxseed oil, sunflower oil, coconut oil, soybean oil, cocoa butter, or a margarine containing a mixture of two or more oils.

9. The soy-based cheese of any one of claims 1-8, wherein said soy-based cheese does not include agar-agar.

10. The soy-based cheese of any one of claims 1-9, wherein said soy-based cheese does not include cyanobacteria or Lactobacillus acidophilus.

11. The soy-based cheese of any one of claims 1-10, said soy-based cheese comprising said sugar.

12. The soy-based cheese of claim 11, wherein said sugar is glucose, fructose, and/or sucrose.

13. The soy-based cheese of claim 11, wherein said sugar is cane sugar, cane juice, corn syrup, brown rice syrup, agave syrup, maple syrup, glycerin, inulin, or maltodextrin.

14. The soy-based cheese of any one of claims 1-13, said soy-based cheese comprising said flavoring.

15. The soy-based cheese of claim 14, wherein said flavoring is a flavoring compound.

16. The soy-based cheese of claim 15, wherein said flavoring compound comprises one or more of acetoin, 5,6-decenoic acid (milk lactone), butanoic acid (butyric acid), gamma-undecalactone, 2,3 butanedione, butyl butyryllactate, delta-decacalactone, delta-tetradecalactone, gamma-tetradecalactone, delta-hexadecalatone, gamma-decalactone, gamma-dodecalactone, delta-dodecalactone, delta-tridecalactone, gamma-hexalactone, hexanoic acid, decanoic acid, octanoic acid, 2-tridecanone, caprylic acid, cis-3-hexanol, dimethyl sulfide, furaneol, indole, methional, methyl amyl ketone, thiophenol, trans-2-hexanal, propionic acid, ethyl butyrate, ethyl caproate, ethyl caprylate, ethyl decanoate, ethyl laurate, ethyl myristate, ethyl oleate, ethyl heptanoate, stearic acid, ethyl palmitate, 2-butanol, 2-methyl-butanal, 3-methyl-butanal, isovaleric acid, guaiacol, pyrizines, butyl alcohol, phenylacetic acid, methyl mercaptan, coconut milk, and coconut cream.

17. The soy-based cheese of claim 14, wherein said flavoring is an herb, a spice, or a vegetable.

18. The soy-based cheese of any one of claims 1-17, said soy-based cheese comprising said antioxidant.

19. The soy-based cheese of claim 18, wherein said antioxidant is vitamin E.

20. The soy-based cheese of any one of claims 1-19, said soy-based cheese comprising said coloring agent.

21. The soy-based cheese of claim 20, wherein said coloring agent is annatto, apocarotenal, beta-carotene, paprika, vegetable juice, or turmeric.

22. The soy-based cheese of any one of claims 1-21, said soy-based cheese comprising said amino acid.

23. The soy-based cheese of claim 22, wherein said amino acid is leucine, alanine, valine, tyrosine, phenylalanine, lysine, isoleucine, glutamic acid, and/or glycine.

24. The soy-based cheese of any one of claims 1-23, said soy-based cheese comprising said gum.

25. The soy-based cheese of claim 24, wherein said gum is carrageenan, xanthan, konjac, guar, gellan, locust bean, or gum arabic.

26. The soy-based cheese of claim 24, wherein said gum is guar gum.

27. The soy-based cheese of any one of claims 1-26, said soy-based cheese comprising said one or more proteins.

28. The soy-based cheese of claim 27, wherein said one or more proteins comprise soy protein isolate or the soluble proteins from soy flour or soy protein isolate.

29. The soy-based cheese of claim 27, wherein said one or more proteins is an isolated protein.

30. The soy-based cheese of claim 29, wherein said isolated protein is selected from the group consisting of a lentil protein, a soy protein, or a pea protein.

31. The soy-based cheese of claim 30, wherein said protein is pea vicilin, pea legumin, soy β-conglycinin, soy glycinin, or a dehydrin protein.

32. The soy-based cheese of any one of claims 27-31, wherein the protein content of said soy-based cheese is similar to that of a dairy based American cheese.

33. The soy-based cheese of claim 32, wherein the protein content of said soy-based cheese is 15% to 20%.

34. The soy-based cheese of claim 33, wherein the protein content of said soy-based cheese is 16% to 19%.

35. The soy-based cheese of any one of claims 1-34, wherein the carboyhydrate content of said soy-based cheese is less than that of a dairy based American cheese.

36. The soy-based cheese of claim 35, wherein the carbohydrate content of said soy-based cheese is 4% to 7%.

37. The soy-based cheese of any one of claims 1-36, wherein the fat content of said soy-based cheese is less than that of a dairy based American cheese.

38. The soy-based cheese of claim 37, wherein the fat content of said soy-based cheese is from 16% to 22%.

39. The soy-based cheese of any one of claims 1-38, wherein said soy-based cheese is meltable.

40. The soy-based cheese of any one of claim 1-39, wherein said soy-based cheese is plant-based.

41. A method of making a soy-based cheese, said method comprising:
a) incubating a mixture of (i) soy milk, (ii) an optional sugar and/or optional one or more proteins, and (iii) a microbial strain or an acid for a period of time sufficient to reach a pH of 5.4 to 6.4;
b) blending said mixture;
c) adding to said blended mixture of b), a low methylester, amidated pectin, an oil, an optional salt, an optional starch, an optional preservative, and an optional coloring agent and blending;
d) heating said mixture of c) to a temperature of 60° C. to 100° C.; and
e) adding to the heated mixture of d), one or more optional sugars and one or more flavorings to produce said soy-based cheese.

42. The method of claim 41, further comprising forming said soy-based cheese in a mold.

43. The method of claim 41 or claim 42, wherein said microbial strain is a bacterial strain.

44. A method of making a soy-based cheese, said method comprising:
a) incubating a mixture of (i) soy milk, (ii) an optional sugar and/or optional one or more proteins, and (iii) a microbial strain or an acid for a period of time sufficient to reach a pH of 5.4 to 5.6;
b) heating said mixture to a temperature between 70° C. and 90° C.;
c) separating the curd and whey in said heated mixture of b) and optionally combining the curd:whey to obtain a ratio of 35:65 to 100:0 curd:whey;
d) adding to said curd:whey of c), a low methylester, amidated pectin, an oil, an optional salt, an optional starch, an optional sugar, an optional coloring agent, and optional preservative;
e) cooking said mixture of d) to a temperature between 80° C. and 100° C. with blending;
f) adding to the cooked mixture of d), one or more flavorings; and
g) blending said cooked mixture off) to obtain said soy-based cheese.

45. The method of claim 44, further comprising forming said soy-based cheese in a mold.

46. The method of claim 44 or claim 45, wherein said microbial strain is a bacterial strain.

47. A soy-based cheese comprising:
a) soy milk;
b) an acid;
c) a low methyl ester, amidated pectin;
d) an oil; and
e) optionally one or more of a salt, a starch, a sugar, a flavoring, an antioxidant, a coloring agent, a gum, an amino acid, quinoa, pyruvic acid or a salt form thereof, a preservative, lactic acid, acetic acid, yeast extract, a dried yeast, one or more proteins, lecithin, a flour, a fiber, or cellulose.

48. The soy-based cheese of claim 47, wherein said acid is selected from the group consisting of citric acid, lemon juice, HCl, and pyruvic acid.

49. A soy-based cheese comprising:
a) soy milk;
b) a microbial strain;
c) a low methyl ester, amidated pectin;
d) one or more proteins;
e) an oil;
f) a salt;
g) a sugar;
h) a gum;
i) a coloring agent; and
j) a flavoring.

50. A soy-based cheese comprising:
a) soy milk;
b) one or more proteins;
c) a low methyl ester, amidated pectin;
d) an oil; and
e) optionally one or more of a salt, a starch, a sugar, a flavoring, an antioxidant, a coloring agent, a gum, an amino acid, quinoa, pyruvic acid or a salt form thereof, a preservative, lactic acid, acetic acid, yeast extract, a dried yeast, lecithin, a flour, a fiber, or cellulose.

51. The soy-based cheese of claim 49 or claim 50, wherein said one or more proteins comprise soy protein isolate or the soluble proteins from soy flour or soy protein isolate.

52. The soy-based cheese of claim 49 or claim 50, wherein said one or more proteins is an isolated protein.

53. The soy-based cheese of claim 52, wherein said isolated protein is selected from the group consisting of a lentil protein, a soy protein, or a pea protein.

54. The soy-based cheese of claim 53, wherein said protein is pea vicilin, pea legumin, soy β-conglycinin, soy glycinin, or a dehydrin protein.

55. The soy-based cheese of any one of claims 49-54, wherein the protein content of said soy-based cheese is at least 15%.

56. The soy-based cheese of any one of claims 49-54, wherein the protein content of said soy-based cheese is similar to a dairy based American cheese.

57. The soy-based cheese of claim 56, wherein the protein content of said soy-based cheese is 15% to 20%.

58. The soy-based cheese of claim 56, wherein the protein content of said soy-based cheese is 16% to 19%.

59. The soy-based cheese of any one of claims 49-58, wherein the carboyhydrate content of said soy-based cheese is less than that of a dairy based American cheese.

60. The soy-based cheese of claim 59, wherein the carbohydrate content of said soy-based cheese is 4% to 7%.

61. The soy-based cheese of any one of claims 49-60, wherein the fat content of said soy-based cheese is less than that of a dairy based American cheese.

62. The soy-based cheese of claim 61, wherein the fat content of said soy-based cheese is from 16% to 22%.

63. The soy-based cheese of any one of claims 49-62, wherein said sugar comprises glucose, fructose, and/or sucrose.

64. The soy-based cheese of any one of claims 49-63, wherein said coloring agent is annatto, apocarotenal, beta-carotene, paprika, vegetable juice, or turmeric.

65. The soy-based cheese of any one of claims 49-64, said soy-based cheese further comprising a preservative.

66. The soy-based cheese of claim 65, wherein said preservative is selected from the group consisting of sorbic acid, natamycin, cultured dextrose, and olive leaf extract.

67. The soy-based cheese of any one of claims 49-66, wherein said soy-based cheese is meltable.

68. The soy-based cheese of any one of claim 49-67, wherein said soy-based cheese is plant-based.
